(19) United States
(12) Patent Application Publication
(10) Pub. No.: US 2012/0255557 A1
(43) Pub. Date: Oct. 11, 2012

(54) WOUND CARE APPARATUS AND METHODS FOR MAKING THE SAME

(76) Inventors: Jeff Baker, Cottonwood Heights, UT (US); Mike Bradfield, Riverton, UT (US); Brad Baker, Riverton, UT (US)

(21) Appl. No.: 13/084,080

(22) Filed: Apr. 11, 2011

(51) Int. Cl. A61G 15/12

(52) U.S. Cl. 128/845

(57) ABSTRACT

A wound care apparatus having a first surface for supporting a first portion of a patient's leg, and a second surface for supporting a second portion of a patient's leg, the apparatus enabling a healthcare professional to provide unaided treatment to the patient's leg.

### BACKGROUND OF THE INVENTION

1. Field of the Invention

The present invention relates generally to systems and methods for treating a wounded leg of a patient. In particular, at least some embodiments of the present invention relate to a wound care apparatus having a dual feature for supporting various anatomical surfaces of a patient's lower extremities.

2. Background and Related Art

The process of wrapping a patient's foot following an injury or medical procedure requires that the patient's foot be at least temporarily suspended in air so that the healthcare professional may have complete access around the patient's foot and leg. Where possible, the patient will lift and hold their leg and foot in a suspended position during the wrapping procedure. However, in some instances where the patient is unconscious or physically incapable of lifting and holding their leg, the healthcare professional must either wrap the leg while holding the foot in the desired position, or must obtain help from a second or third healthcare professional to complete the wrapping. In both instances, the efficiency of the wrapping procedure is compromised which may result in the patient receiving an ineffective treatment. Further, these limitations may contribute to back and shoulder injuries of the healthcare professional as they attempt to support the heavy leg of an obese patient.

Thus, while techniques currently exist for treating and wrapping a patient's leg, challenges still exist. Accordingly, it would be an improvement in the art to augment or even replace current techniques with other techniques.

### SUMMARY OF THE INVENTION

The present invention relates generally to systems and methods for treating a wounded leg of a patient. Further, the present invention relates to systems and methods for providing access for treatment by other healthcare professionals such as podiatrists or chiropodists. In particular, at least some embodiments of the present invention relate to a wound care apparatus having a dual feature for supporting various anatomical surfaces of a patient's lower extremities.

Some implementations of the present invention include a wound care apparatus having a leg support having a first position and a second position, the first position presenting a first surface to support a first portion of a patient's leg, and the second position presenting a second surface to support a second portion of the patient's leg. In some implementations, the first surface of the wound care apparatus is a calf support and the second surface is a heel support. Further, in some implementations the first surface is positioned opposite the second surface.

Some implementations of the present invention further include a leg support hingedly moveable between the first position and the second position. Further, some implementations include a wound care apparatus having a post that is coupled to a leg rest, wherein the leg rest is a portion of at least one of a bed and a chair. In some implementations, the post is removably coupled to the leg rest, and in other implementations the post further includes an extension arm.

Some implementations of the present invention provide a system for treating a patient's leg, the system including a leg support having a first position and a second position, the first position presenting a first surface to support a first portion of a patient's leg, and the second position presenting a second surface to support a second portion of the patient's leg, the system further including a leg rest having a socket for selectively receiving a portion of the leg support, wherein the leg support supports the patient's leg such that a space is provided between the patient's leg and the leg rest.

Further, in some implementations of the present invention a method for manufacturing a wound care apparatus is provided, wherein the method includes the steps of providing a leg support having a first position and a second position, the first position presenting a first surface to support a first portion of a patient's leg, and the second position presenting a second surface to support a second portion of the patient's leg. The method may further include the steps of positioning the first surface opposite the second surface, providing a leg rest having a mounting plate for receiving a portion of the post, and adjustably coupling the portion of the post to the mounting plate. Still further, some methods of the present invention include a step for providing the post with an extension arm.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1A is a perspective view of a wound care apparatus in a first position in accordance with a representative embodiment of the present invention;

FIG. 1B is a side plan view of a wound care apparatus in a first position in accordance with a representative embodiment of the present invention;

FIG. 2A is a perspective view of an articulated chair having a wound care apparatus in a first position in accordance with a representative embodiment of the present invention;

FIG. 2B is a side plan view of an articulated chair having a wound care apparatus in a first position supporting a patient's leg, shown in phantom, in accordance with a representative embodiment of the present invention;

FIG. 3A is a perspective view of a wound care apparatus in a second position in accordance with a representative embodiment of the present invention;

FIG. 3B is a plan side view of a wound care apparatus in a second position in accordance with a representative embodiment of the present invention;

FIG. 4A is a perspective view of an articulated chair having a wound care apparatus in a second position in accordance with a representative embodiment of the present invention;

FIG. 4B is a plan side view of an articulated chair having a wound care apparatus in a second position in accordance with a representative embodiment of the present invention;

FIG. 5A is a perspective view of a wound care apparatus and receiver for selectively coupling the wound care apparatus to a leg rest in accordance with a representative embodiment of the present invention; and

FIG. 5B is a plan view of a wound care apparatus and receiver for selectively coupling the wound care apparatus to a leg rest in accordance with a representative embodiment of the present invention.

### DETAILED DESCRIPTION OF THE INVENTION

The present invention relates generally to systems and methods for treating a wounded leg of a patient. In particular, at least some embodiments of the present invention relate to a wound care apparatus having a dual feature for supporting various anatomical surfaces of a patient's lower extremities.

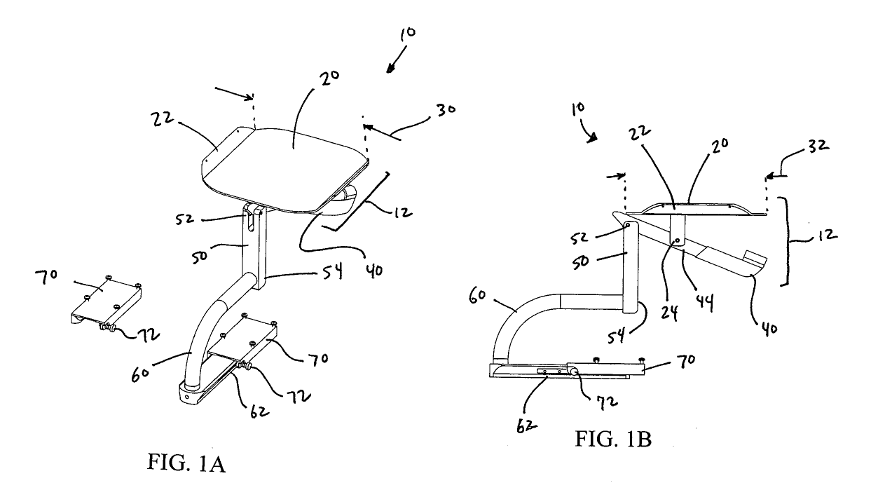

Referring now to FIGS. 1A and 1B, a wound care apparatus 10 in accordance with the present invention is shown in a first position. Wound care apparatus 10 generally includes a leg support 12 having a first surface 20 for supporting a first portion of a patient's leg. For example, in some embodiments first surface 20 comprises a calf support having a width 30 sufficient to accommodate placement of the patient's calf. In some embodiments, first surface 20 further comprises one or more side guards 22 whereby to prevent the calf portion of the patient's leg from being unintentionally displaced from first surface 20. In some embodiments, first surface 20 is configured to have a length 32 approximately equal to an average length of a patient's triceps surae. Accordingly, when the patient's leg is supported by first surface 20, the foot and ankle of the patient extend beyond first surface 20, thereby suspending the foot and ankle of the patient to provide 360° of access to these portions of the patient's lower extremities.

In some embodiments, first surface 20 further comprises a support strut 24 that is fixedly coupled to an underside of first surface 20, and is pivotally coupled to a support strut portion 44 of a second surface 40. As such, first surface 20 is capable of pivoting in forward and rearward directions to accommodate various angles of contact for the patient's calf. This pivoting feature provides adjustability thereby allowing leg support 12 to be used with patients of varying heights. Further, in some embodiments support strut 24 is pivotally coupled to the underside of first surface 20, thereby providing axial rotation of first surface 20 relative to a vertical axis of support strut 24.

Wound care apparatus 10 further comprises a post 50 having a first end 52 pivotally coupled to a terminal end of support strut 44, and a second end 54 fixedly coupled to an extension arm 60. In some embodiments, second end 54 is adjustably coupled to extension arm 60, thereby providing axial rotation of post 50 relative to a fixed position of extension arm 60. Extension arm 60 further comprises a coupler 62 for attaching wound care apparatus 10 to a desired surface via receiver 70.

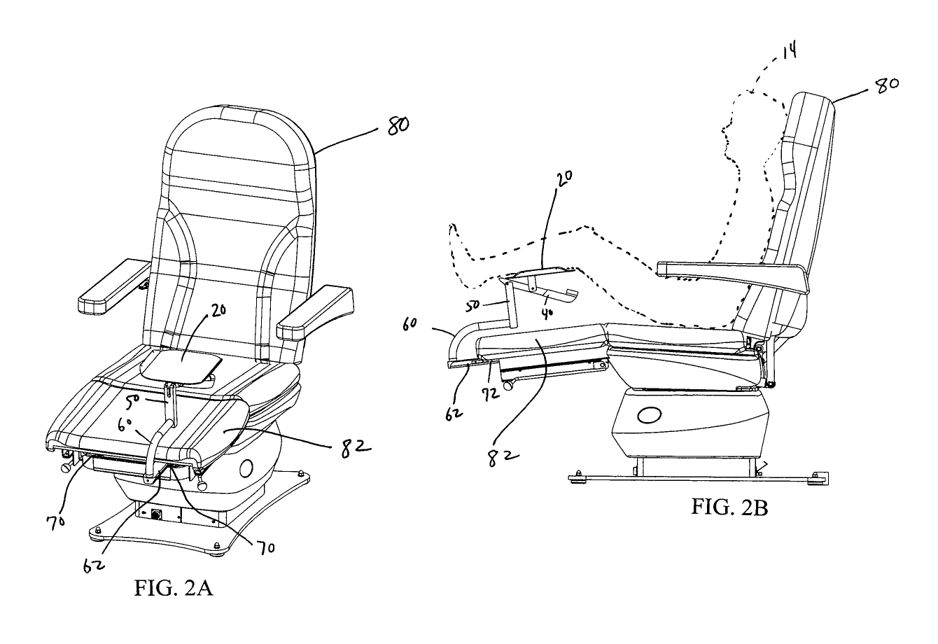

For example, in some embodiments receiver 70 is attached to a leg rest 82 portion of a patient support device, such as an articulated chair 80, as shown in FIGS. 2A and 2B. In some embodiments, coupler 62 comprises an extended track having grooves for slidably inserting with receiver 70. Accordingly, in some embodiments receiver 70 comprises a set of rails or pins configured to seat within the grooves of coupler 62 such that coupler 62 is capable of being laterally adjusted within receiver 70 in a forward and rearward direction. In some embodiments receiver 70 further comprises a set pin 72 that is capable of being inserted into coupler 62 thereby arresting a position of coupler 62 within receiver 70. Thus, some embodiments of the present invention provide an adjustable wound care apparatus 10 configured to accommodate patients of various heights. Further, in some embodiments leg rest 82 comprises both a left and a right receiver 70 thus permitting wound care apparatus 10 to be mounted on either side of the leg rest 82. As such, a single wound care apparatus 10 may be used to treat both the left and right legs of the patient.

With continued reference to FIGS. 2A and 2B, when the wound care apparatus 10 is in the first position, as shown, first surface 20 is made available to support the calf portion of the patient's 14 lower leg. Accordingly, the foot and ankle portions of patient's 14 lower leg extend beyond first surface 20 and are suspended in air thereby providing the healthcare professional with 360° access to the patient's 14 foot and ankle. In some embodiments, the healthcare professional adjusts the position of coupler 62 within receiver 70 so that first surface 20 is properly aligned with the patient's 14 calf. An arched or other contoured configuration of extension arm 60 permits rearward positioning of coupler 62 within receiver 70 without causing contact between post 50 and leg rest 82.

While in the first position, the healthcare professional may treat the foot and ankle of patient 14 without being required to manipulate, lift, handle, reposition or hold the patient's leg. Further, wound care apparatus 10 eliminates the need for the healthcare professional to acquire assistance from additional healthcare professionals or technicians to treat the foot and ankle of the patient 14. Thus, wound care apparatus 10 overcomes the previously discussed limitations inherent in the prior art.

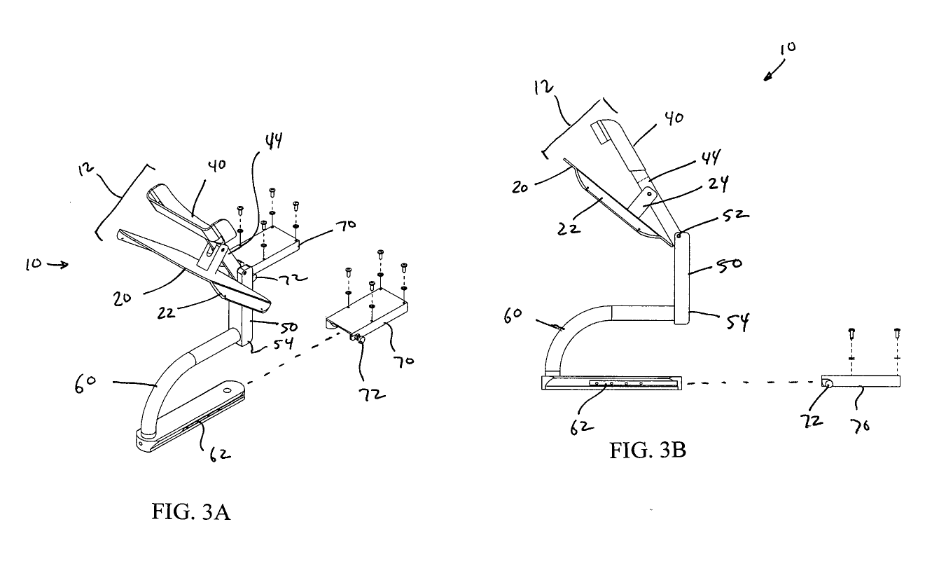

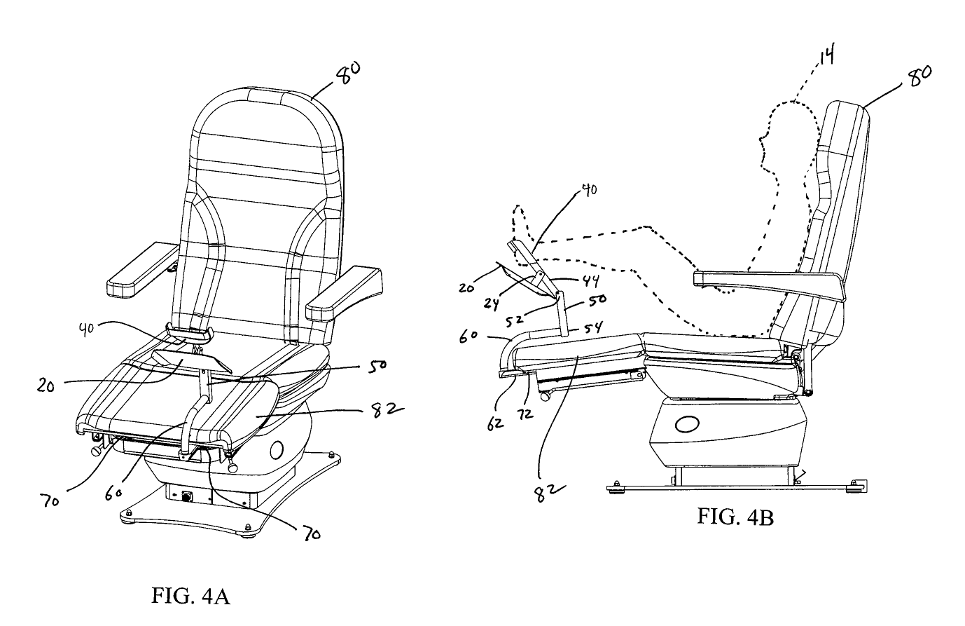

Referring now to FIGS. 3A and 3B, in some embodiments wound care apparatus 10 further comprises a second position, as shown. The second position is characterized by the leg support 12 portion of the apparatus being pivotally rotated in a forward direction such that the first surface 20 is faced in an approximately downward direction, and a second surface 40 is made accessible to the patient 14. In some embodiments, second surface 40 comprises a heel stirrup for receiving and supporting heel and foot portions of the patient's leg, as shown in FIGS. 4A and 4B. The hinged or pivoting connection between first end 52 of post 50 and support strut 44 is configured such that the rotation of leg support 12 is limited to a range of approximately 120° between first position and second position. In some embodiments, the hinged or pivoting connection is adjustable such that a user can increase or decrease the range rotation between the first and second positions, as may be desired.

With continued reference to FIGS. 4A and 4B, when the wound care apparatus 10 is in the second position, as shown, second surface 40 is made available to support the heel and sole portions of the patient's 14 foot. Accordingly, the upper ankle and calf portions of the patient's lower leg are suspended in air thereby providing the healthcare professional with 360° access to the patient's 14 upper ankle and calf. In some embodiments, the healthcare professional adjusts the position of coupler 62 within receiver 70 so that a desired position of the patient's 14 leg is maintained for a desired treatment. For example, in some embodiments leg rest 82 is adjusted in a forward direction thereby extending the patient's leg to accommodate a taller patient. Thus, wound care apparatus 10 is may be configured and adjusted to fit the various anatomical features of a patient.

While in the second position, the healthcare professional may treat the upper ankle and calf of patient 14 without being required to manipulate, lift, handle, reposition or hold the patient's leg. Further, wound care apparatus 10 eliminates the need for the healthcare professional to acquire assistance from additional healthcare professionals or technicians to treat the patient's 14 leg. Thus, wound care apparatus 10 further overcomes the previously discussed limitations inherent in the prior art.

The first and second support surfaces 20 and 40 of the present invention enable a healthcare professional to provide unaided treatment to a patient's lower extremities. In some embodiments, a healthcare professional first positions the patient's calf on the first surface of the leg support 12 and treats the suspended portions of the patient's lower leg. To treat the non-suspended portions of the patient's leg, the healthcare professional lifts the patient's leg and rotates the leg support 12 to the second position, thereby exposing the second surface 40. The healthcare professional then places the patient's heel and foot in the heel or foot stirrup feature of second surface 40, thereby suspending the previously unsuspended portions of the patient's lower leg. The healthcare professional is then able to treat the newly suspended portions of the patient's lower leg.

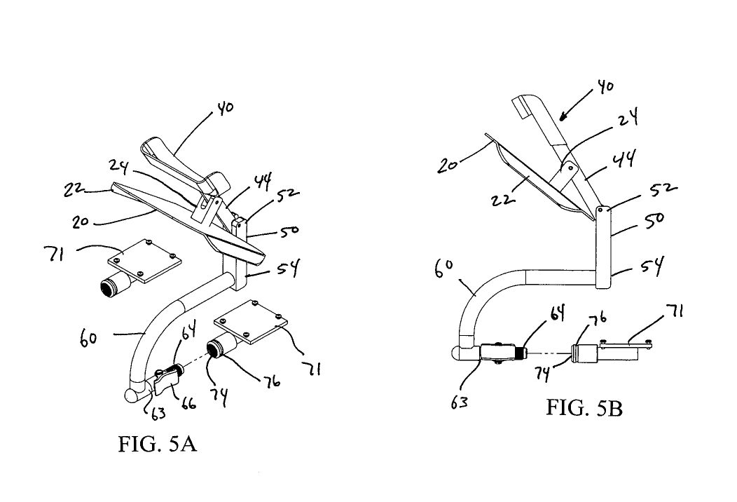

One having skill in the art will appreciate that wound care apparatus 10 may be coupled to leg rest 82 by any number of alternative coupling methods. For example, in some embodiments coupler 63 comprises a set of male key splines 64 and receiver 71 comprises a set of female key splines 74 configured to compatibly receive male key splines 64 as shown in FIGS. 5A and 5B. In some embodiments, coupler 63 further comprises a latch or locking clip 66 configured to selectively engage a retaining groove 76 located on an external surface of receiver 71. Thus, an engagement between clip 66 and groove 76 secures wound care apparatus 10 to leg rest 82. One having skill in the art will further appreciate that leg rest 82 may comprise part of a bed, a non-articulated chair, a gurney, or other similar type of furniture designed to accommodate treatment of a patient.

Some embodiments of the present invention provide a method for manufacturing a wound care apparatus in accordance with the above description. For example, some methods in accordance with the present invention comprise the steps of providing a leg support having a first position and a second position, wherein the first position presents a first surface to support a first portion of a patient's leg, and the second position presents a second surface to support a second portion of the patient's leg. Some methods further include the step of positioning the first surface opposite the second surface, wherein the leg support is hingedly coupled to a post such that the leg support is hingedly moveable between the first and second positions.

Some methods of the present invention further comprise a step for attaching the leg support and post to a leg rest of a chair or bed via a mounting plate or receiver coupled to the chair or bed. Some methods of the present invention further include the step of adjustably coupling a portion of the wound care apparatus' post to the mounting plate of the bed or chair. Further still, some methods of the present invention comprise a step for providing the post with an extension arm, thereby accommodating adjustability of the apparatus' position relative to the stationary position of the leg rest.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A wound care apparatus comprising a leg support having a first position and a second position, the first position presenting a first surface to support a first portion of a patient's leg, and the second position presenting a second surface to support a second portion of the patient's leg.

2. The apparatus of claim 1, wherein the first surface is a calf support and the second surface is a heel support.

3. The apparatus of claim 1, wherein the first surface is positioned opposite the second surface.

4. The apparatus of claim 1, further comprising a post hingedly coupled to the leg support.

5. The apparatus of claim 4, wherein the leg support is hingedly moveable between the first position and the second position.

6. The apparatus of claim 4, wherein the post is further coupled to a leg rest.

7. The apparatus of claim 6, wherein the leg rest comprises a portion of at least one of a bed and a chair.

8. The apparatus of claim 6, wherein the post is removably coupled to the leg rest.

9. The apparatus of claim 4, wherein the post further comprises an extension arm.

10. A method for manufacturing a wound care apparatus, the method comprising providing a leg support having a first position and a second position, the first position presenting a first surface to support a first portion of a patient's leg, and the second position presenting a second surface to support a second portion of the patient's leg.

11. The method of claim 10, wherein the first surface is a calf support and the second surface is a heel support.

12. The method of claim 10, further comprising the step of positioning the first surface opposite the second surface.

13. The method of claim 10, further comprising the step of providing a post hingedly coupled to the leg support.

14. The method of claim 13, wherein the leg support is hingedly moveable between the first position and the second position.

15. The method of claim 13, further comprising the steps of:
providing a leg rest having a mounting plate for receiving a portion of the post; and
adjustably coupling the portion of the post to the mounting plate.

16. The method of claim 15, wherein the leg rest comprises a portion of at least one of a bed and a chair.

17. The method of claim 13, further comprising the step of providing the post with an extension arm.

18. A system for treating a patient's leg, the system comprising:
a leg support having a first position and a second position, the first position presenting a first surface to support a first portion of a patient's leg, and the second position presenting a second surface to support a second portion of the patient's leg; and
a leg rest having a socket for selectively receiving a portion of the leg support, wherein the leg support supports the patient's leg such that a space is provided between the patient's leg and the leg rest.

19. The system of claim 18, wherein the first surface is a calf support and the second surface is a heel support.

20. The system of claim 18, wherein the leg support is hingedly coupled to the portion of the leg support.
